(19) United States
(12) Patent Application Publication
(10) Pub. No.: US 2008/0157478 A1
(43) Pub. Date: Jul. 3, 2008

(54) Seal Arrangement For a Rolling Bearing

(76) Inventors: Hikaru Ishida, Mie (JP); Yoshimitsu Hirasawa, Mie (JP); Atsushi Kawakita, Mie (JP); Yusuke Shimizu, Mie (JP)

Correspondence Address: WENDEROTH, LIND & PONACK, L.L.P., 2033 K STREET N. W., SUITE 800, WASHINGTON, DC, 20006-1021, US

(21) Appl. No.: 11/667,472

(22) PCT Filed: Dec. 14, 2005
(86) PCT No.: PCT/JP2005/022930

§ 371 Date: May 10, 2007

(30) Foreign Application Priority Data
Dec. 15, 2004 (JP) 2004-363132

(51) Int. Cl. F16J 15/32

(52) U.S. Cl. 277/353

(57) ABSTRACT

In a contact type seal arrangement for a rolling bearing, it is aimed to reduce torque and improve sealability by improving the lip structure of each seal member.

Each seal member 11 has a branch portion 15 at substantially the same height as the land 3 of the inner ring. A main lip 16 is defined by its portion extending radially inwardly from the branch portion 15. The tip of the main lip 16 is brought into contact with the outer groove wall 21 of the seal groove 4 to define a contact seal 25. An auxiliary lip 17 is defined by a portion extending axially inwardly from the branch portion 15. A labyrinth seal 19 is defined between the tip of the auxiliary lip 17 and the inner groove wall 18 of the seal groove 4.

### TECHNICAL FIELD

This invention relates to a seal arrangement for a roller bearing, and particularly relates to the shapes of lips of seal members forming a contact type seal arrangement.

### BACKGROUND ART

Rolling bearings are provided with a seal arrangement for preventing leakage of grease in the bearings, as well as entry of foreign matter from outside. There are two types of such seal arrangements. One type includes metallic shield members fitted in the bearing. The other type includes seal members made of an elastic material such as synthetic rubber and fitted in the bearing. The present invention belongs to the latter type, i.e. the type including seal members. This latter type is further classified into a non-contact type in which seal members are fixed to one of the bearing rings while facing the other bearing with a labyrinth gap defined therebetween, and a contact type in which the seal members are brought into contact with the other bearing ring without a gap therebetween. The present invention is directed to the latter contact type.

Typically, a contact type seal arrangement using seal members comprises seal grooves formed in the radially outer surface of the inner ring of the bearing, seal member fixing grooves formed in the radially inner surface of the outer ring so as to oppose the respective seal grooves, and seal members fitted between these grooves. Each seal member has at its radially inner portion a main lip and an auxiliary lip and has its outer edge fitted in and fixed to one of the fixing grooves formed in the radially inner surface of the outer ring. The main lip is in contact with the seal groove to define a contact seal. A labyrinth seal is defined between the auxiliary lip and the radially outer surface of the inner ring (see Patent documents 1-4). The seal members may each include a plurality of auxiliary lips (see Patent documents 2 and 4).

For the shapes of the main and auxiliary lips, the tip of the synthetic rubber forming each seal member is typically bifurcated to define a main lip and an auxiliary lip. In one arrangement, the main lip is provided inside while the auxiliary lip is provided outside (see Patent documents 1 and 3). Conversely, in another arrangement, the main lip is provided outside and the auxiliary lip is provided inside (see Patent documents 2 and 4).

For improved sealability, the interference of the main lip is preferably as large as possible. But the larger the interference, the higher the torque of the bearing. Conversely, the smaller the interference, the lower the toque. But in this case, sealability also decreases. During high speed rotation of the bearing, the internal pressure of the bearing rises. Thus, if sealability is insufficient, grease may be discharged together with air, thus polluting the surroundings of the bearing. Leakage of grease could also result in shortage of grease in the bearing, thus shortening the life span of the bearing. Thus, if low torque is required, it was necessary to reduce the interference of the main lip, and simultaneously reduce the amount of grease sealed in the bearing. It was further necessary to prevent leakage of grease to maintain the amount of sealed grease.

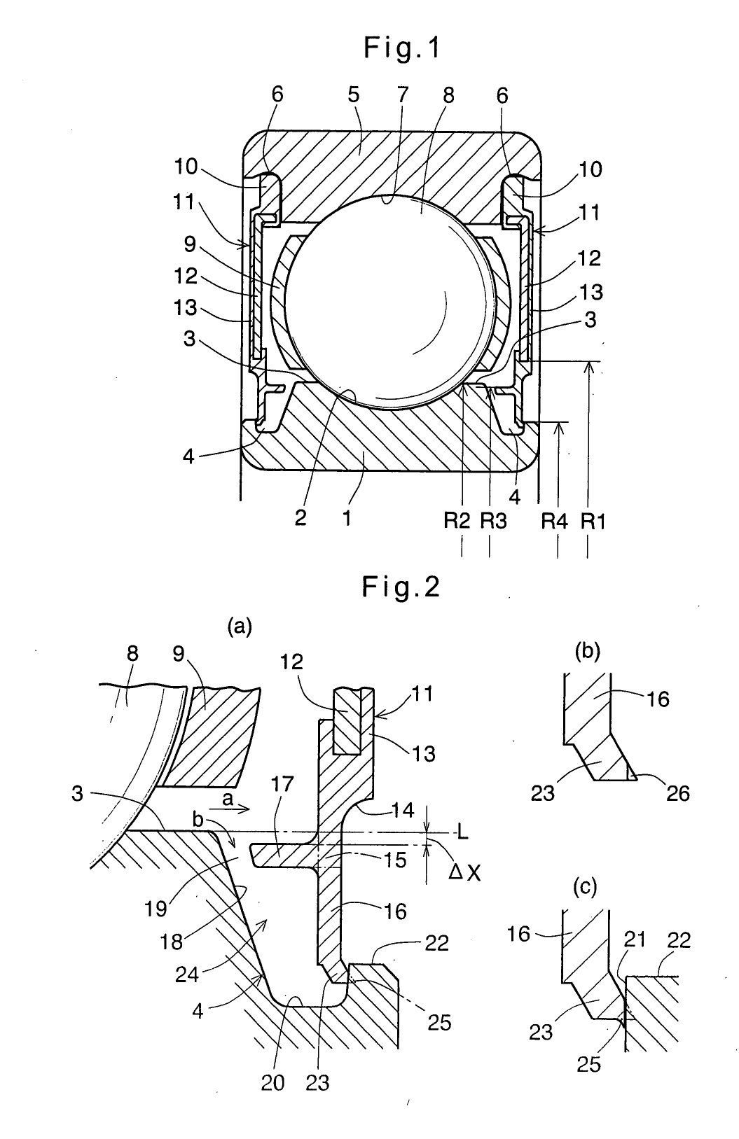

Patent document 1: JP patent publication 46-39361B (Embodiments; FIG. 1)
Patent document 2: JP utility model publication 3-121225A (FIG. 2)
Patent document 3: JP patent publication 2003-13977A (First embodiment, FIG. 1)
Patent document 4: JP patent publication 2004-68924A (First embodiment, FIG. 2)

### DISCLOSURE OF THE INVENTION

### Object of the Invention

As in Patent documents 1 and 3, if the main lip is provided inside, the internal pressure of the bearing is directly borne by the main lip, so that there is a tendency to set the interference relatively high to maintain high sealability. This results in high torque. In contrast, in an arrangement in which the main lip is provided outside as in Patent documents 2 and 4, because the internal pressure of the bearing is reduced by the auxiliary lip, which is provided inside, even if the interference of the main lip is set relatively low, good sealability is achieved with low torque.

But with increasing rotational speeds of today's bearings, it is required to further reduce torque and further improve sealability.

An object of the present invention is therefore to further reduce torque and further improve sealability of a contact type seal arrangement of the type in which the main lips are provided outside.

### Means to Achieve the Object

In order to achieve this object, the present invention provides a seal arrangement for a rolling bearing comprising circumferential seal grooves formed in a radially outer surface of an inner ring, seal members having their outer edges fixed to a radially inner surface of an outer ring that faces the seal grooves, each of the seal members having a main lip and an auxiliary lip provided at a radially inner portion thereof, the main lip being in contact with one of the seal grooves to define a contact seal, the auxiliary lip being disposed close to the seal groove or a portion near the seal groove to define a labyrinth seal, characterized in that each of the seal members having a branch portion at substantially the same height as that of the radially outer surface of the inner ring, that the main lip is formed by a portion of the seal member extending radially inwardly from the branch portion, the main lip having its tip in contact with an outer groove wall of the seal groove to define the contact seal, and that the auxiliary lip is formed by a portion of the seal member extending axially inwardly from the branch portion, the labyrinth seal being defined between the tip of the auxiliary lip and an inner groove wall of the seal groove.

In this seal arrangement, grease is sealed by the labyrinth seals each defined by an auxiliary lip and the contact seals each defined by a main lip, and is prevented from leaking. The contact seals and the labyrinth seals also prevent entry of foreign matter from outside. A grease sump having a relatively large volume is defined by each of the main lips and the auxiliary lips and the inner groove wall of the seal groove facing these lips. The grease sump serves to reduce the pressure under which grease leaks.

Also, because the radially outer surface of the auxiliary lip extends axially at substantially the same height as that of the radially outer surface of the inner ring, grease pushed out of the raceway groove can smoothly flow toward its radially outer surface. The branch portion from which the main lip and the auxiliary lip branch is located “at substantially the same height as that of the radially outer surface of the inner ring”. This means that the branch portion is located on or near the axial extension of the radially outer surface of the inner ring, so that the auxiliary lip extends from the branch portion toward the inner ring at substantially the same height as that of its radially outer surface.

If the auxiliary lip is offset radially outwardly from the extension of the radially outer surface of the inner ring, the auxiliary lip preferably has on its tip surface a tapered surface having an inclination angle exceeding 90° with respect to the radially outer surface of the inner ring. By providing such a tapered surface, grease can smoothly flows onto the radially outer surface of the auxiliary lip.

### EFFECTS OF THE INVENTION

As described above, in the same manner as in conventional arrangements in which the main lip is disposed outside and the auxiliary lip is disposed inside, the inner auxiliary lip serves to reduce the internal pressure, thus reducing the internal pressure that acts on the main lip. According to the present invention, the main lip and the auxiliary lip are connected to each other through the branch portion in the shape of an inverted L, and a grease sump having a large volume is defined between these portions and the inner groove wall of the seal groove. The grease sump serves to further reduce the internal pressure, so that it is possible to reduce the interference of the main lip, thus reducing torque, while simultaneously improving sealability.

Further, because the radially outer surface of the auxiliary lip is located at substantially the same height as that of the radially outer surface of the inner ring, grease pushed out of the raceway groove can be smoothly directed toward the radially outer surface of the auxiliary lip. This makes it possible to reduce the amount of grease flowing into the grease sump through the labyrinth seal. Thus, it is possible to further reduce torque and improve sealability.

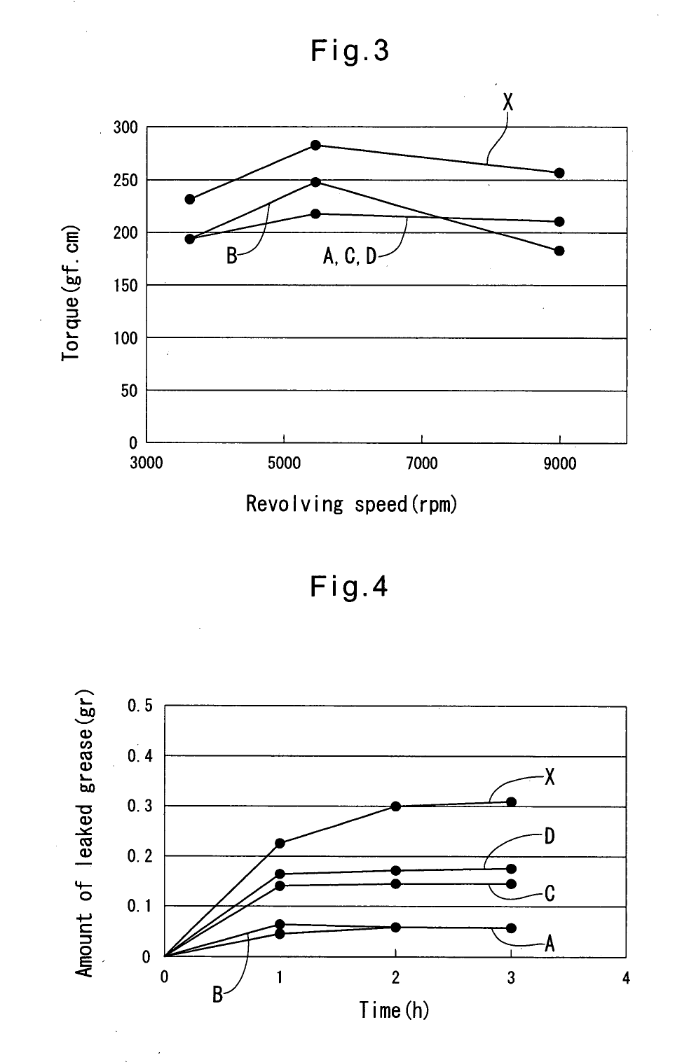

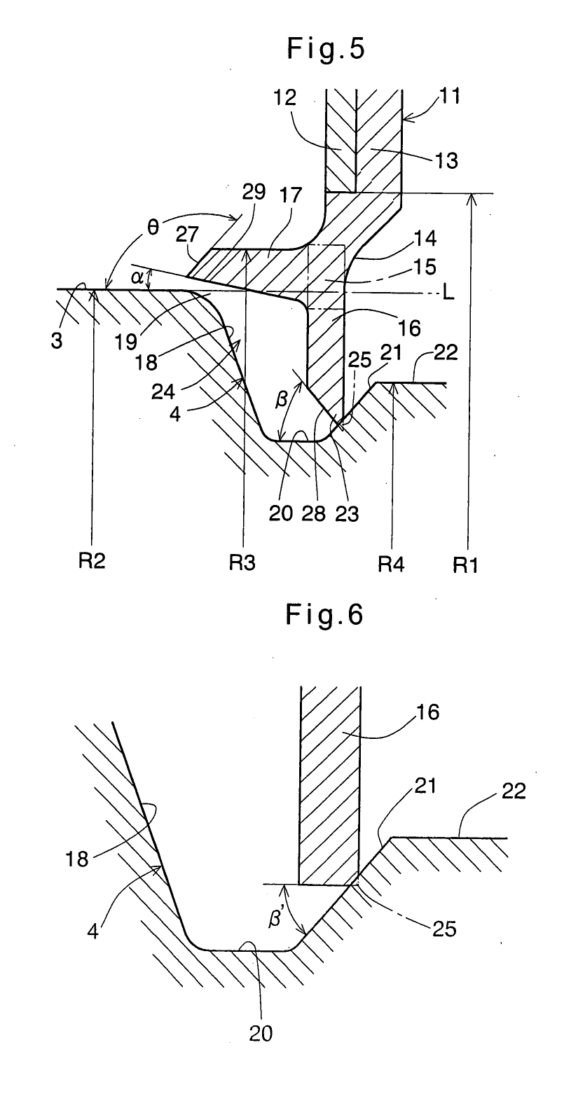

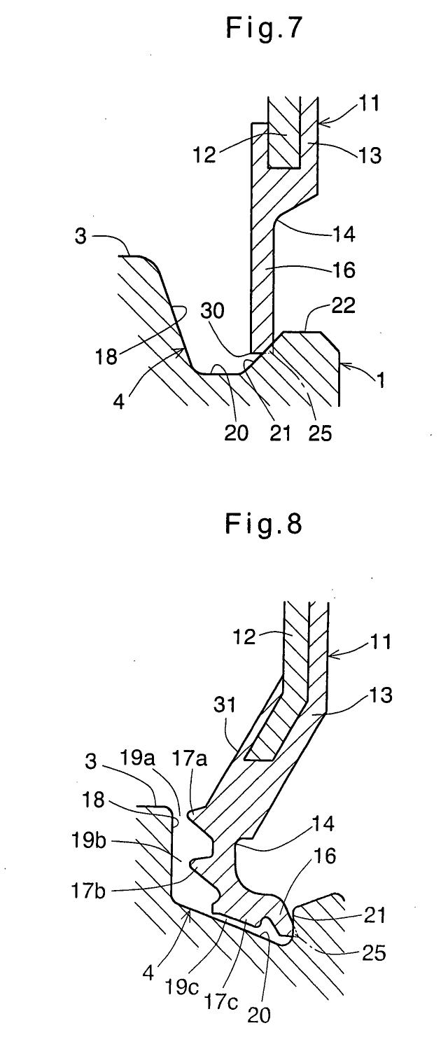

### BRIEF DESCRIPTION OF THE DRAWINGS

[FIG. 1] a sectional view of Embodiment 1

[FIG. 2] (a) a partial enlarged sectional view of the same, (b) an enlarged sectional view showing a small groove portion of a slide contact portion, and (c) an enlarged sectional view showing a contact seal of the slide contact portion

[FIG. 3] a graph showing actual measurement results of torque values for respective embodiments

[FIG. 4] a graph showing actual measurement results of amounts of leakage of grease for respective embodiments

[FIG. 5] a partial enlarged sectional view of Embodiment 2

[FIG. 6] a partial enlarged sectional view of Comparative Example

[FIG. 7] a partial enlarged sectional view of Embodiment 3

[FIG. 8] a partial enlarged sectional view of Embodiment 4

### DESCRIPTION OF NUMERALS

1. Inner ring
2. Raceway groove
3. Land
4. Seal groove
5. Outer ring
6. Seal member fixing groove
7. Raceway groove
8. Ball
9. Retainer
11. Seal member
12. Metallic core
13. Synthetic rubber
14. Constricted portion
15. Branch portion
16. Main lip
17. Auxiliary lip
18. Inner groove wall
19. Labyrinth seal
20. Groove bottom
21. Outer groove wall
22. Outer land
23. Sliding contact portion
25. Contact seal
26. Small groove portion
27. Tapered surface
28. Tapered surface
29. Inclined surface
30. End surface
31. Inclined surface

### BEST MODE FOR EMBODYING THE INVENTION

Hereinbelow, the embodiments of this invention are described with reference to the attached drawings.

### Embodiment 1

The rolling bearing of Embodiment 1, shown in FIGS. 1 and 2, has circumferential seal grooves 4 formed in lands 3 on both sides of a raceway groove 2 formed in the radially outer surface of the inner ring 1. Seal member fixing grooves 6 are formed in the radially inner surface of the outer ring 5 so as to face the respective seal grooves 4. A raceway groove 7 is formed in the radially inner surface of the outer ring 5 so as to face the raceway groove 2. Balls 8 are disposed between the raceway grooves 2 and 7. The balls 8 are circumferentially spaced by a predetermined distance from each other by a retainer 9.

An annular seal member 11 is disposed between each seal groove 4 and the corresponding seal member fixing groove 6. The seal members 11 are formed by molding a synthetic rubber 13 on a metallic core 12. Their outer edges 10 are fitted in and fixed to the respective seal member fixing grooves 6. The inner radius R1 of the metallic cores 12 is greater than the outer radius R2 of the lands 3 of the inner ring 1 (in the claims, the lands 3 are referred to as radially outer surface of the inner ring). Between the inner radius of each metallic core 12 and an axial extension L of the land 3 (see FIG. 2), the synthetic rubber 13 is formed with a constricted portion 14 (see FIG. 2). At the constricted portion 14, the synthetic rubber 13 has a reduced wall thickness.

As shown in FIG. 2, the synthetic rubber 13 has a straight portion extending radially inwardly from the constricted portion 14. A branch portion 15 is provided at an intermediate point of the straight portion. The portion of the straight portion extending radially inwardly from the branch portion 15 serves as a main lip 16. The synthetic rubber 13 further includes a portion extending axially inwardly from the branch portion 15. This portion serves as an auxiliary lip 17. The main lip 16 and the auxiliary lip 17 are connected together at the branch portion 15 in the shape of an inverted L.

The branch portion 15 is a portion where the extension of the thickness of the main lip 16 intersects the extension of the thickness of the auxiliary lip 17 (portion enclosed by the one-dot chain lines of FIG. 2(a)). The illustrated branch portion 15 is offset radially inwardly from the extension L of the land 3 by a minute amount (ΔX).

Due to the offset ΔX, a step (R2-R3) forms between the land 3 and the auxiliary lip 17. But the step will not be an obstacle to the flow of grease from the land 3 toward the auxiliary lip 17 (see the arrow a). But if ΔX is too large, the volume of the below-described grease sump 24 decreases, thereby reducing the effect of relieving the leakage pressure of grease. Thus, the value of ΔX is limited to a range at which the offset ΔX does not reduce the effect of relieving the leakage pressure of grease.

If the branch portion 15 is offset radially outwardly from the illustrated position so that the relation R3>R2 is met, and as a result, the step becomes an obstacle to the flow of grease, countermeasures taken in the below-described Embodiment 2 (see the tapered surface 27 of FIG. 5) are preferably taken.

The tip of the auxiliary lip 17 is formed into an inclined surface parallel to the inclined inner groove wall 18 of the seal groove 4, thus defining a labyrinth seal 19 between the inclined surface and the inner groove wall 18.

In FIG. 2(a), the groove bottom of the seal groove 4 is indicated by 20, its outer groove wall is by 21 and the outer land is indicated by 22. The outer land 22 has a radius R4 that is smaller than the radius R2 of the land 3.

At the tip of the main lip 16, a slide contact portion 23 slightly warped toward the outer surface is provided. Its pointed tip is brought into contact with the outer groove wall 21 of the seal groove 4 with a predetermined interference, thus forming a contact seal 25 (see FIG. 2(c)). In FIG. 2(c), the shape of the tip of the slide contact portion 23 in its natural state is shown by one-dot chain line. The shape of the tip when deformed due to contact is shown by the solid line. FIG. 2(c) thus shows that the contact seal 25 is formed by the deformed portion. In other figures, the contact seal 25 is shown only by the shape in its natural state for convenience sake.

As described above, the main lip 16 and the auxiliary lip 17 are connected together through the branch portion 15 in the shape of an inverted L. The portion defined by the inverted L-shaped portion and the inner groove wall 18 of the seal groove 4, which faces the inverted L-shaped portion, serves as a grease sump 24 having a relatively large volume. The grease sump 24 communicates with the interior of the bearing through the labyrinth seal 19 and is closed by the contact seal 25.

To reduce pressure during abnormal rise in the pressure in the bearing, two circumferentially symmetrical small groove portions 26 (see FIG. 2(b)) are formed in the tip of the slide contact portion 23.

The seal arrangement of Embodiment 1 is structured as described above, and is used with grease sealed in the bearing. Because the leakage pressure of grease is reduced by the labyrinth seal 19, which is provided inside the contact seal 25 of the main lip 16, the interference of the main lip 16 at the contact seal 25 can be made small compared to the arrangement in which the pressure is directly borne (arrangement in which the main lip is provided inside). This interference is adjustable by changing the thickness of the constricted portion 14, thickness of the main lip 16 or the slide contact portion 23, or the like.

In the case of the present invention, it is possible to further reduce the interference of the contact seal 25 for the following reasons.

That is, the first reason is that a portion of the grease pushed out of the raceway groove 2 through each land 3 flows onto the radially outer surface of the auxiliary lip 17 as shown by the arrow a. Because the radially outer surface of the auxiliary lip 17 is parallel to the bearing axis, grease is prevented from being pushed back. In the conventional arrangement, as in the abovementioned Patent documents 2 and 4, grease tends to be pushed back into the bearing because the radially outer surface of the auxiliary lip is inclined inwardly, which increases the grease pressure. In the case of the present invention, because the push back force is relatively weak, the influence on the grease pressure is small, so that grease is less likely to flow toward the labyrinth seal 19 (see the arrow b). This reduce the rise in pressure in the grease sump 24.

The second reason is that because the grease sump 24 is defined between the main lip 16 and the auxiliary lip 17, which are connected to each other through the branch portion 15, and the inner groove wall 18 of the seal groove 4, which faces the lips 16 and 17, and has a relatively large volume, the internal pressure of the grease sump 24 further decreases.

In order to confirm these effects, comparative experiments were conducted for an article of the invention according to Embodiment 1 (both sides sealed), and the following existing article.

### (1) Existing Article

Article manufactured based on what is disclosed in FIG. 1 of Patent document 1 (both sides sealed)

### (2) Contents of the Experiments

For the article according to the invention and the existing article, the torque value under an axial load of 4 kgf was actually measured. The actually measured values are shown in FIG. 3. X indicates torque values for the existing article and A indicates torque values for the article of the invention. Also, a grease leakage performance test was conducted under a radial load of 20 kgf. The test results are shown in FIG. 4. X indicates amounts of leakage of grease for the existing article and A indicates amounts of leakage of grease for the article of the invention.

### (3) Consideration of the Experiment Results

For the torque values shown in FIG. 3, the article of the invention A was lower by about 40 gf·cm (20%) than the existing article X. It was therefore discovered that torque decreased. For the amounts of leakage of grease shown in FIG. 4, with the article of the invention A, the accumulated leakage amount until a stable state is reached decreased to about ¼ compared to the existing article X. Thus, it was discovered that the seal performance improved.

### Embodiment 2

The seal arrangement of Embodiment 2, shown in FIG. 5, is basically the same as Embodiment 1. The differences are that the radial position of the branch portion 15 is determined such that it is on the extension L of the land 3, and that most part of the auxiliary lip 17 is located above the extension L (i.e. at the radially outer portion of the seal member 11). The maximum-diameter portion of the auxiliary lip 17 has a radius R3 that is greater than the radius R2 of the land 3. With this arrangement, although the volume of the grease sump 24 increases, there arises a problem that the tip surface of the auxiliary lip 17 becomes an obstacle to the flow of grease from the land 3 toward the radially outer surface of the auxiliary lip 17. In order to avoid this problem, on the tip of the lip 17, a tapered surface 27 is formed which has an inclination angle θ of not less than 90° with respect to the land 3.

The radially inner surface of the auxiliary lip 17 is inclined at a predetermined angle α with respect to the land 3. A labyrinth seal 19 is defined between this inclined surface 29 and the inner groove wall 18 of the seal groove 4.

A tapered surface 28 is also formed on the inner surface of the main lip 16 at its tip so that the angle β between the tapered surface 28 and the outer groove wall 21 of the seal groove 4 is not less than 90°. By setting the angle β at such a large value, compared to a narrow angle β′ of less than 90° (see FIG. 6, which shows a comparative example), it becomes more difficult for grease to pass through the contact seal 25 of the main lip 16. Otherwise, this embodiment is the same in structure, operation and effect achieved as Embodiment 1.

For the seal arrangement of Embodiment 2, experiments similar to the ones conducted for Embodiment 1 were conducted. Actually measured torque values are shown by B in FIG. 3, while actually measured leakage amounts of grease are shown by B in FIG. 4. As will be apparent from these results, low torque and high sealability were achieved to the same extent as in Embodiment 1.

### Embodiments 3 and 4

Embodiment 3, shown in FIG. 7, and Embodiment 4, shown in FIG. 8, were invented before Embodiments 1 and 2. They are disclosed as comparative examples of Embodiments 1 and 2.

In Embodiment 3 shown in FIG. 7, each seal member 11 has only a main seal lip 16. The main seal lip 16 has a constant width and is formed with a widthwise end surface 30 at the tip thereof. The end surface 30 has its outer corner in contact with the outer groove wall 21 of the seal groove 4 to define a contact seal 25. This embodiment differs from Embodiments 1 and 2 in that no auxiliary lip is provided.

It was confirmed that torque values C when the interference of the main lip 16 was set to be substantially the same as in Embodiments 1 and 2 were substantially the same as values A in FIG. 3. As shown by the letter C in FIG. 4, sealability was about ½ of the existing article X. Thus, it was discovered that sealability is inferior to A and B. This may be due to the fact that neither the auxiliary lip 17 nor the grease sump 24 is provided. This means that the auxiliary lip 17 and the grease sump 24 as used in Embodiments 1 and 2 contribute to improved sealability.

In Embodiment 4 shown in FIG. 8, the radially inner portion of the metallic core 12 is bent inwardly in the shape of “<”, the synthetic rubber 13 is also bent along the bent inner portion of the core so as to be close to the inner groove wall 18 of the seal groove 4, and auxiliary lips 17a and 17b are formed on the surface facing the inner groove wall 18 in two tiers. Further, a third auxiliary lip 17c is provided along the groove bottom 20 of the seal groove 4. Labyrinth seals 19a, 19b and 19c are defined by these auxiliary lips 17a-17c. A constricted portion 14 is formed on the surface opposite to the auxiliary lips 17a-17c, i.e. the outer surface. The outer surface of the main lip 16 is connected to the tip of the constricted portion 14, while the inner surface of the main lip 16 is connected to the tip of the third auxiliary lip 17c. The tip of the main lip 16, at which its inner and outer surfaces meet, is brought into contact with the outer groove wall 21 of the seal groove 4, defining a contact seal 25.

Embodiment 4 significantly differs from Embodiments 1 and 2 in that there are three auxiliary lips 17a-17c (and thus three labyrinth seals 19a-19c), that the grease sump defined between the portions between the adjacent auxiliary lips 17a-17c and the portion between the auxiliary lip 17c and the main lip 16 and the groove wall of the seal groove 4 that faces these portions has a small volume, and that the amount of axial protrusion of the auxiliary lip 17a is small and its base is connected to the inner surface of the inwardly bent synthetic rubber 13.

It was confirmed that torque values D when the interference of the main lip 16 was set to be substantially the same as in Embodiments 1 and 2 were substantially the same as values A in FIG. 3. As shown by the letter D in FIG. 4, sealability was about the same as the C values. Thus, it was discovered that sealability is inferior to A and B. This is presumably because the effect of providing the auxiliary lips 17a-17c in three tiers scarcely revealed, the volume of the grease sump was small, and the amount of axial protrusion of the auxiliary lip 17a is small and its radially outer surface was inclined so as to be close to the inclined surface 31 of the synthetic rubber 13.

1-3. (canceled)

4. A seal arrangement for a rolling bearing comprising circumferential seal grooves (4) formed in a radially outer surface of an inner ring (1), seal members (11) having their outer edges fixed to a radially inner surface of an outer ring (5) that faces said seal grooves (4), each of said seal members (11) having a main lip (16) and an auxiliary lip (17) provided at a radially inner portion thereof, said main lip (16) being in contact with one of said seal grooves (4) to define a contact seal (25), said auxiliary lip (17) being disposed close to said seal groove (4) or a portion near said seal groove (4) to define a labyrinth seal (19), characterized in that each of said seal members (11) having a branch portion (15) at a position offset radially inwardly by a minute amount (ΔX) from an axial extension (L) of the radially outer surface of the inner ring (1), that said main lip (16) is formed by a portion of said seal member extending radially inwardly from said branch portion (15), said main lip (16) having its tip in contact with an outer groove wall (21) of said seal groove (4) to define said contact seal (25), and that said auxiliary lip (17) is formed by a portion of the seal member extending axially inwardly from said branch portion (15) and forming a step of said minute amount (ΔX) relative to said radially outer surface of said inner ring (1), said labyrinth seal (19) being defined between the tip of said auxiliary lip (17) and an inner groove wall of said seal groove (4).

5. The bearing seal arrangement of claim 4 characterized in that said main lip (16) and said auxiliary lip (17) are connected to each other through said branch portion (15) in the shape of an inverted L, and that a grease sump (24) is defined by said main and auxiliary lips and the inner groove wall (18) of said seal groove (4) facing said lips, said grease sump communicating with the interior of the bearing (1) through said labyrinth seal (19), and being closed by said contact seal (25).

6. A seal arrangement for a rolling bearing comprising circumferential seal grooves (4) formed in a radially outer surface of an inner ring (1), seal members (11) having their outer edges fixed to a radially inner surface of an outer ring (5) that faces said seal grooves (4), each of said seal members (11) having a main lip (16) and an auxiliary lip (17) provided at a radially inner portion thereof, said main lip (16) being in contact with one of said seal grooves (4) to define a contact seal (25), said auxiliary lip (17) being disposed close to said seal groove (4) or a portion near said seal groove (4) to define a labyrinth seal (19), characterized in that each of said seal members (11) having a branch portion (15) at a position including an axial extension (L) of the radially outer surface of the inner ring (1), that said main lip (16) is formed by a portion of said seal member extending radially inwardly from said branch portion (15), said main lip (16) having its tip in contact with an outer groove wall (21) of said seal groove (4) to define said contact seal (25), that said main lip (16) has on its inner surface a tapered surface (28) forming an angle (β) of 90° or more relative to said outer groove wall (21), that said auxiliary lip (17) is formed by a portion of the seal member extending axially inwardly from said branch portion (15), and that said auxiliary lip (17) is formed at a height offset radially outwardly from the extension (L) of the radially outer surface of said inner ring (1), and has on its tip surface a tapered surface (27) forming an angle θ exceeding 90° relative to the radially outer surface of said inner ring (1), said labyrinth seal (19) being defined between the radially inner surface of said auxiliary lip (17) and an inner groove wall (18) of said seal groove (4).
